(19) United States
(12) Patent Application Publication
(10) Pub. No.: US 2025/0335327 A1
(43) Pub. Date: Oct. 30, 2025

(54) METHODS, APPARATUSES, DEVICES AND MEDIUM FOR MODEL PERFORMANCE EVALUATION

(71) Applicants: Beijing Bytedance Network Technology Co., Ltd., Beijing (CN); Lemon Inc., Grand Cayman (KY)

(72) Inventors: Jiankai SUN, Los Angeles, CA (US); Xin YANG, Los Angeles, CA (US); Chong WANG, Los Angeles, CA (US); Junyuan XIE, Beijing (CN); Di WU, Beijing (CN)

(21) Appl. No.: 18/865,611

(22) PCT Filed: Apr. 27, 2023
(86) PCT No.: PCT/CN2023/091142

§ 371 Date: Jul. 16, 2025

(30) Foreign Application Priority Data
May 13, 2022 (CN) 202210524005.9

(51) Int. Cl. G06F 11/34

(52) U.S. Cl. CPC G06F 11/3466

(57) ABSTRACT

According to embodiments of the disclosure, methods, apparatuses, devices, and medium for model performance evaluation are provided. The method comprises: obtaining, at a client node, a plurality of predicted scores output by a machine learning model for a plurality of data samples, the plurality of predicted scores respectively indicating predicted probabilities that the plurality of data samples belong to a first category or a second category; modifying a plurality of ground-truth labels based on a randomized response mechanism, to obtain a plurality of protected labels, the plurality of ground-truth labels respectively labeling that the plurality of data samples belong to the first category or the second category; determining error metric information related to a predetermined performance indicator of the machine learning model based on the plurality of protected labels and the plurality of predicted scores; and sending the error metric information to a server node. In this way, while a model performance evaluation is implemented, the purpose of privacy protection for local labeled data of a client node is achieved.

This application claims priority to Chinese Patent Application No. 202210524005.9, filed on May 13, 2022 and entitled “METHODS, APPARATUSES, DEVICES, AND MEDIUM FOR MODEL PERFORMANCE EVALUATION”.

### FIELD

Example embodiments of the present disclosure generally relate to the field of computers, and in particular, to methods, apparatuses, devices, and computer-readable storage medium for model performance evaluation.

### BACKGROUND

Currently, machine learning has been widely applied, and its performance generally usually improves with the increase of data volume. In an ideal situation, it may be considered that high-quality data samples and sufficient labeled data may be collected in a centralized manner for training of a machine learning model. However, in many real-world scenarios, there is a problem of so-called data silos, where data is usually dispersed and isolated, stored on different entities (e.g., enterprises, user ends). With the increasing attention paid to data privacy protection issues, it is difficult to further improve the current centralized machine learning system. Therefore, federated learning is emerging. Federated learning may achieve performance consistent with traditional machine learning algorithms in an encrypted environment where data leaves a local node.

In federated learning, it is expected to better protect data privacy, including the privacy of label data corresponding to data samples.

### SUMMARY

According to example embodiments of the present disclosure, there is provided a solution for model performance evaluation.

In a first aspect of the present disclosure, there is provided a method for model performance evaluation. The method includes: obtaining, at a client node, a plurality of predicted scores output by a machine learning model for a plurality of data samples, the plurality of predicted scores respectively indicating predicted probabilities that the plurality of data samples belong to a first category or a second category: modifying a plurality of ground-truth labels based on a randomized response mechanism, to obtain a plurality of protected labels, the plurality of ground-truth labels respectively labeling that the plurality of data samples belong to the first category or the second category: determining error metric information related to a predetermined performance indicator of the machine learning model based on the plurality of protected labels and the plurality of predicted scores; and sending the error metric information to a server node.

In a second aspect of the present disclosure, there is provided a method for model performance evaluation. The method includes: receiving, at a server node, error metric information related to a predetermined performance indicator of a machine learning model from a plurality of client nodes, respectively, the error metric information being determined by a client node based on a plurality of protected labels of the corresponding client, the plurality of protected labels being generated by applying a randomized response mechanism to a plurality of ground-truth labels; determining an error value of the predetermined performance indicator based on the error metric information; and determining a corrected value of the predetermined performance indicator by correcting the error value.

In a third aspect of the present disclosure, there is provided an apparatus for model performance evaluation. The apparatus includes a score obtaining module configured to obtain, at a client node, a plurality of predicted scores output by a machine learning model for a plurality of data samples, the plurality of predicted scores respectively indicating predicted probabilities that the plurality of data samples belong to a first category or a second category: a label modifying module configured to modify a plurality of ground-truth labels based on a randomized response mechanism, to obtain a plurality of protected labels, the plurality of ground-truth labels respectively labeling that the plurality of data samples belong to the first category or the second category: an information determining module configured to determine error metric information related to a predetermined performance indicator of the machine learning model based on the plurality of protected labels and the plurality of predicted scores; and an information sending module configured to send the error metric information to a server node.

In a fourth aspect of the present disclosure, there is provided an apparatus for model performance evaluation. The apparatus includes an information receiving module configured to receive, at a server node, error metric information related to a predetermined performance indicator of a machine learning model from a plurality of client nodes, respectively, the error metric information being determined by a client node based on a plurality of protected labels of the corresponding client, the plurality of protected labels being generated by applying a randomized response mechanism to a plurality of ground-truth labels; an indicator determining module configured to determine an error value of the predetermined performance indicator based on the error metric information; and an indicator correcting module configured to determine a corrected value of the predetermined performance indicator by correcting the error value.

In a fifth aspect of the present disclosure, there is provided an electronic device. The device includes at least one processing unit; and at least one memory coupled to the at least one processing unit and storing instructions executable by the at least one processing unit. The instructions, when executed by the at least one processing unit, cause the device to perform the method of the first aspect.

In a sixth aspect of the present disclosure, there is provided an electronic device. The device includes at least one processing unit; and at least one memory coupled to the at least one processing unit and storing instructions executable by the at least one processing unit. The instructions, when executed by the at least one processing unit, cause the apparatus to perform the method of the second aspect.

In a seventh aspect of the disclosure, there is provided a computer-readable storage medium. The medium has a computer program stored thereon which, when executed by a processor, implements the method of the first aspect.

In an eighth aspect of the disclosure, there is provided a computer-readable storage medium. The medium has a computer program stored thereon which, when executed by a processor, implements the method of the second aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of various embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be applied;

FIG. 2 illustrates a flowchart of a signaling flow for model performance evaluation according to some embodiments of the disclosure:

FIG. 3 illustrates a schematic diagram of an example of applying a randomized response mechanism to ground-truth labels according to some embodiments of the disclosure:

FIG. 4 illustrates a flowchart of a process for model performance evaluation at a client node according to some embodiments of the disclosure:

FIG. 5 illustrates a flowchart of a process of model performance evaluation at a server node according to some embodiments of the disclosure:

FIG. 6 illustrates a block diagram of an apparatus for model performance evaluation at a client node according to some embodiments of the disclosure:

FIG. 7 illustrates a block diagram of an apparatus for model performance evaluation at a server node according to some embodiments of the disclosure; and

FIG. 8 illustrates a block diagram of a computing device/system in which one or more embodiments of the present disclosure may be implemented.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising”, and similar terms would be appreciated as open inclusion, that is, “comprising but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

It can be understood that the data involved in this technical solution (including but not limited to the data itself, data observation or use) should comply with the requirements of corresponding laws, regulations and relevant provisions.

It is to be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that execute operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

As used herein, the term “model” can learn an association between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

A “neural network” is a machine learning network based on deep learning. A neural network is capable of processing inputs and providing corresponding outputs, and typically includes an input layer and an output layer and one or more hidden layers between the input layer and the output layer. Neural networks used in deep learning applications often include many hidden layers, thereby increasing the depth of the network. The layers of a neural network are connected in sequence such that the output of the previous layer is provided as the input of the subsequent layer, where the input layer receives the input of the neural network, and the output of the output layer serves as the final output of the neural network. Each layer of a neural network consists of one or more nodes (also called processing nodes or neurons), each of which processes input from the previous layer.

Generally, machine learning may generally involve three stages, i.e., a training stage, a test stage, and an application stage (also referred to as an inference stage). At the training stage, a given machine learning model may be trained using a large scale of training data to iteratively update parameter values, until the model can obtain, from the training data, consistent inference that satisfies an expected goal. Through the training process, the machine learning model may be regarded as being capable of learning the association between the input and the output (also referred to an input-output mapping) from the training data. At the test stage, a test input is applied to the trained machine learning model to test whether the model can provide an accurate output, to determine the performance of the model. At the application stage, the model may be used to process a real-world model input based on the trained parameter values and to determine a corresponding output.

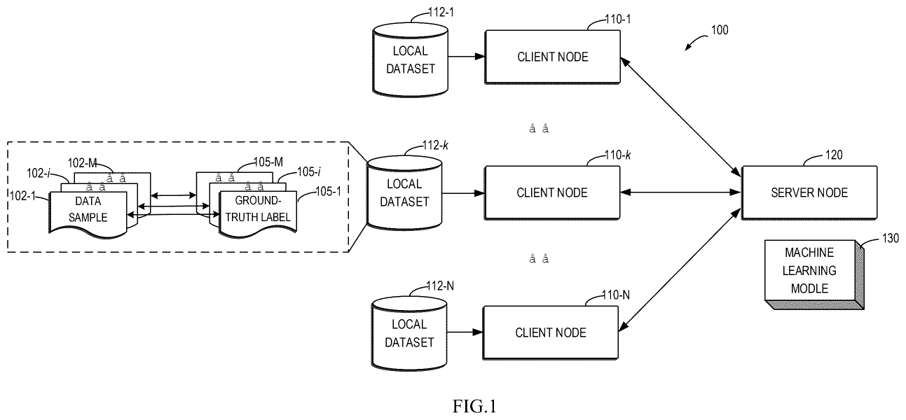

FIG. 1 illustrates a schematic diagram of an example environment 100 in which the embodiments of the present disclosure can be implemented. The environment 100 involves a federated learning environment, which includes N client nodes 110-1, . . . 110-k, . . . 110-N (where N is an integer greater than 1, k=1, 2, . . . . N), and a service node 120. The client nodes 110-1, . . . 110-k, . . . 110-N may maintain their respective local datasets 112-1, . . . 112-k, . . . 112-N. For the sake of discussion, the client nodes 110-1, . . . 110-k, . . . 110-N may be collectively or individually referred to as client nodes 110, and the local datasets 112-1, . . . 112-k . . . 112-N may be collectively or individually referred to as local datasets 112.

In some embodiments, the client node 110 and/or the service node 120 may be implemented at a terminal device or a server. The terminal device may be any type of mobile terminal, fixed terminal, or portable terminal, including mobile phones, desktop computers, laptop computers, notebook computers, netbook computers, tablet computers, media computers, multimedia tablets, personal communication system (PCS) devices, personal navigation devices, personal digital assistants (PDAs), audio/video player, digital cameras/camcorders, positioning devices, television receivers, radio broadcast receivers, electronic book devices, gaming devices, or any combination of the foregoing, including accessories and peripherals of these devices, or any combination thereof. In some embodiments, the terminal device may also be able to support any type of interface to the user (such as “wearable” circuitry, etc.). Servers are various types of computing systems/servers capable of providing computing capabilities including but not limited to mainframes, edge computing nodes, computing devices in cloud environments, and the like.

In federated learning, a client node refers to a node that provides part of data for application training, verification or evaluation of machine learning models. The client node may also be referred to as a client, a terminal node, a terminal device, a user equipment, etc. In federated learning, a server node refers to a node that aggregates the results at the client node.

In the example in FIG. 1, assume that N client nodes 110 jointly participate in the training of a machine learning model 130, and collect the intermediate results in the training to the server node 120, so that the server node 120 may update a parameter set of the machine learning model 130. The complete set of local data of these client nodes 110 constitute a complete training data set of the machine learning model 130. Therefore, according to the federated learning mechanism, the server node 120 may generate a global machine learning model 130.

For the machine learning model 130, the local data set 112 at the client node 110 may include data samples and ground-truth labels. FIG. 1 specifically illustrates the local data set 112-k at the client node 110-k, which includes a data sample set and a ground-truth label set. The data sample set includes multiple (M) data samples 102-1, 102-i, . . . 102-M (collectively or individually referred to as data sample 102), and the ground-truth label set includes a corresponding multiple (M) ground-truth labels 105-1, 105-i, . . . 105-M (collectively or individually referred to as ground-truth label 105). M is an integer greater than 1, i=1, 2, . . . . M. Each data sample 102 may be marked shows with a corresponding ground-truth label 105. The data sample 102 may correspond to the input of the machine learning model 130, and the ground-truth label 105 indicates the true output of the data sample 102. A ground-truth label is an important part of supervised machine learning.

In the embodiments of the present disclosure, the machine learning model 130 may be constructed based on various machine learning or deep learning model architectures, and may be configured to implement various prediction tasks, such as various classification tasks, recommendation tasks, and so on. Accordingly, the machine learning model 130 may also be referred to as a prediction model, a recommendation model, a classification model, and the like.

The data sample 102 may include input information related to the specific task of the machine learning model 130, and the ground-truth label 105 is related to the expected output of the task. As an example, in a binary classification task, the machine learning model 130 may be configured to predict whether the data sample input belongs to a first category or a second category, and the ground-truth label is used to mark that the data sample actually belongs to the first category or the second category. Many practical applications may be classified as such binary tasks, such as the conversion of recommended items (such as clicking, purchasing, registering, or other demand behaviors) in a recommendation task, and so on.

It should be understood that FIG. 1 only illustrates an example of the federated learning environment. According to federated learning algorithms and practical application needs, the environment may also be different. For example, although illustrated as a separate node, in some applications, the server node 120 may also serve as a client node in addition to serving as a central node to provide part of data for model training, model performance evaluation, and so on. The embodiments of the present disclosure are not limited in this respect.

In the training phase of the machine learning model 130, there are some mechanisms to protect the local data of each client node 110 from leakage. For example, during the model training, the client node 110 does not need to leak local data samples or label data, but sends gradient data computed based on to the local training data to the server node 120 for the server node 120 to update a parameter set of the machine learning model 130.

In some cases, it is also expected to evaluate the performance of the trained machine learning model. The evaluation of model performance also requires data, including data samples required for model input and the corresponding label data of data samples. The performance of the machine learning model may be measured by one or more performance indicators. Different performance indicators may measure the difference between the predicted output given by the machine learning model for the data sample set and the true output indicated by the ground-truth label set from different perspectives. Generally, if the difference between the predicted output given by the machine learning model and the true output is small, it means that the performance of the machine learning model is better. It can be seen that the performance indicator of the machine learning model usually needs to be determined based on the ground-truth label set of the data samples.

As the data supervision system continues to strengthen, the requirements for data privacy protection are becoming increasingly higher. The ground-truth labels of data samples also need to be protected to avoid being leaked. For example, for the data owner in the recommendation task, a real conversion behavior of a user to the recommended items involves user privacy, which is sensitive information and needs to be protected.

Therefore, how to not only determine the performance indicators of the machine learning model, but also protect the local labeled data of the client node from being leaked is a challenging task. There are currently no very efficient solutions to solve this issue.

According to embodiments of the present disclosure, there is provided a solution for model performance evaluation, which may protect local labeled data of the client node. Specifically, at the client node, a set of ground-truth labels corresponding to a set of data samples is modified by applying a randomized response (RR) mechanism to obtain a set of protected labels. The client node determines metric information related to a performance indicator of the machine learning model based on the set of protected labels and predicted scores output by the machine learning model for the set of data samples. Since the set of labels is a set of protected labels after modifying, the determined metric information is not accurate metric information, which is referred to as “error metric information”. The client sends the error metric information to the server node.

At the server node, the server node receives respective error metric information from a plurality of client nodes and determines an error value of the performance indicator based on the error metric information. The server node further corrects the error value to obtain a corrected value of the performance indicator.

According to the embodiments of the present disclosure, respective client nodes do not need to expose a local set of ground-true labels, and at the same time, the server node may also calculate a value of the performance indicator based on feedback information of the client node. In this way, while model performance evaluation is achieved, the objective of privacy protection for local labeled data of the client node is achieved.

The following will continue to describe some example embodiments of the present disclosure with reference to the accompanying drawings.

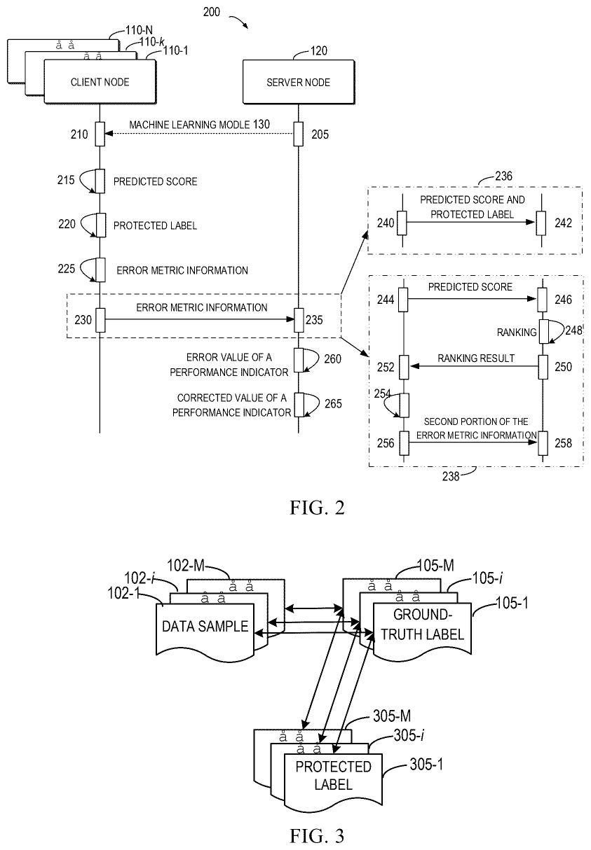

FIG. 2 illustrates a schematic block diagram of a signaling flow 200 for model performance evaluation according to some embodiments of the present disclosure. For ease of discussion, refer to the environment 100 in FIG. 1 for discussion. The signaling flow 200 involves the client node 110 and the server node 120.

In the embodiments of the present disclosure, it is assumed that the performance of the machine learning model 130 is to be evaluated. In some embodiments, the machine learning model 130 to be evaluated may be a global machine learning model determined based on the training process of federated learning, for example the client node 110 and the service node 120 participating in the training process of the machine learning model 130. In some embodiments, the machine learning model 130 may also be a model obtained in any other way, and the client node 110 and the server node 120 may not participate in the training process of the machine learning model 130. The scope of the present disclosure is not limited in this regard.

In some embodiments, as shown in the signaling flow 200, the server node 120 sends 205 the machine learning model 130 to N client nodes 110. After receiving 210 the machine learning model 130, each client node 110 may perform a subsequent evaluation process based on the machine learning model 130. In some embodiments, the machine learning model 130 to be evaluated may also be provided to the client node 110 in any other appropriate manner.

In embodiments of the present disclosure, operations at the client node side will be described from the perspective of a single client node.

During the process of performing model performance evaluation, the client node 110 obtains 215 a plurality of predicted scores output by the machine learning model 130 for a plurality of data samples 102. In some embodiments, the client node 110 may apply respective data samples 102 to the machine learning model 130 as inputs to the model and obtain a predicted score output by the machine learning model 130. For example, assuming that the set of data samples of the client node 110-k is Xₖ, the machine learning model 130 is denoted as f( ) the set of predicted scores for the set of data samples may be denoted as s^{k}=f(Xₖ), where k=1, 2, . . . , N.

In the embodiments of the present disclosure, particular attention is paid to the performance indicators of the machine learning model in implementing a binary classification task. Each predicted score may indicate predicted probabilities that the corresponding data sample 102 belongs to the first category or the second category. These two categories may be configured based on the actual task requirements.

The value range of predicted score output by the machine learning model 130 may be set arbitrarily. For example, the predicted score may be a value in a continuous value range (for example, a value between 0 and 1), or it may be a value in multiple discrete values (for example, it may be one of the discrete values such as 0, 1, 2, 3, 4, and 5). In some examples, a higher prediction score can indicate a higher probability of data sample 102 belonging to the first category and a lower probability of belonging to the second category. Of course, the opposite setting is also possible. For example, a higher prediction score can indicate that the probability of data sample 102 belonging to the second category is higher, while the probability of belonging to the first category is lower.

The client node 110 also modifies 220, based on a randomized response mechanism, a plurality of ground-truth labels 105 (which may also be referred to as true value labels) that correspond to respective data samples 102 to obtain a plurality of protected labels.

It should be understood that although the obtaining of the predicted score at 215 and the randomized response mechanism applied to the ground-truth label at 220 are described in order, the operations may be performed in any order without limitation.

The ground-truth label 105 is used to label that the corresponding data sample 102 belongs to the first category or the second category. In the following, for the convenience of discussion, data samples belonging to the first category are sometimes referred to as positive samples, positive examples or positive-category samples, and data samples belonging to the second category are sometimes referred to as negative samples, negative examples or negative-category samples. In some embodiments, each ground-truth label 105 may have one of two values, which are respectively used to indicate the first category or the second category. In the following embodiments, for the sake of discussion, the value of the ground-truth label 105 corresponding to the first category may be set to “1”, which indicates that the data sample belongs to the first category and is a positive sample. In addition, the value of the ground-truth label 105 corresponding to the second category may be set to “0”, which indicates that the data sample belongs to the second category and is a negative sample.

In embodiments of the present disclosure, to achieve privacy protection of the ground-truth labels while determining the performance indicator of the machine learning model 130, the ground-truth labels are converted to protected labels by a randomized response mechanism. FIG. 3 illustrates an example of a protected label resulting from applying a randomized response mechanism to the ground-truth label 105 according to some embodiments of the disclosure. As shown in FIG. 3, after applying the randomized response mechanism, M ground-truth labels 105 corresponding to the M data samples 102 will correspond to the protected labels 305-1, . . . , 305-i, . . . , 305-M (collectively or individually referred to as protected labels 305).

The randomized response mechanism is one of differential privacy (DP) mechanisms. For a better understanding of embodiments of the present disclosure, the differential privacy and randomized response mechanism will first be briefly introduced below.

Assuming ϵ, δ are real numbers greater than or equal to 0, that is ϵ, δ∈ [symbol] ≥0, and [symbol] is a randomized mechanism (random algorithm). The so-called randomized mechanism refers to that for a particular input, the output of the mechanism is not a fixed value, but rather follows a certain distribution. For the randomized mechanism [symbol] , the randomized mechanism [symbol] may be considered to have (ϵ, δ) differential privacy if the following situation is satisfied: for any two adjacent training datasets D, D′, and for any subset S of possible outputs of [symbol] there is:

$$Pr [ ( D ) ∈ S ] \leq {e}^{ϵ} \cdot Pr [ ( {D}^{′} ) ∈ S ] + δ . \qquad ( 1 )$$

Additionally, the randomized mechanism [symbol] may also be considered to have ϵ-differential privacy (ϵ-DP) if δ=0. In the differential privacy mechanism, for a randomized mechanism [symbol] with (ϵ, δ) differential privacy or ϵ-differential privacy, it is expected that the distribution of two outputs obtained after respectively acting on two adjacent datasets is difficult to distinguish. In this way, by observing the output result, the observer can hardly perceive a tiny change in the input data set of the algorithm, thereby achieving the purpose of privacy protection. If the randomized mechanism [symbol] acts on any adjacent data set and the probability of obtaining a specific output is almost the same, it is considered that the algorithm has difficulty in achieving the effect of differential privacy.

In embodiments herein, attention is paid to differential privacy for labels of data samples, and the labels indicate binary classification results. Therefore, following the setting of the differential privacy, the label differential privacy may be defined. Specifically, assuming ϵ, δ are real numbers greater than or equal to 0, that is ϵ, δ∈ [symbol] ≥0, [symbol] is a randomized mechanism (random algorithm). The randomized mechanism [symbol] may be considered to have (ϵ,δ)-label differential privacy if the following situation is satisfied: for any two adjacent training datasets D, D′, their difference only lies in the difference of a single data sample and for any subset S of possible outputs of [symbol] , there is:

$$Pr [ ( D ) ∈ S ] \leq {e}^{ϵ} \cdot Pr [ ( {D}^{′} ) ∈ S ] + δ \qquad ( 2 )$$

Additionally, the randomized mechanism [symbol] may also be considered to have ϵ-differential privacy (ϵ-DP) if δ=0 That is, it is expected that after changing the label of a data sample, the distribution of output results from the randomized mechanism [symbol] is still small, making it difficult for an observer to perceive changes of the label.

The randomized response mechanism is a random mechanism applied for the purpose of differential privacy protection. The randomized response mechanism is defined as follows: Assume ϵ is a parameter, and y∈[0,1] is a known value of the ground-truth label in the randomized response mechanism. If for a value [symbol] of a ground-truth label, the randomized response mechanism derives a random value [symbol] from the following probability distribution:

$$Pr [ \tilde{y} - \hat{y} ] = \{ \begin{matrix}\frac{{e}^{\text{?}}}{1 + {e}^{\text{?}}} & for y = \hat{y} , \\ \frac{1}{1 + {e}^{\text{?}}} & for other cases\end{matrix} \qquad ( 3 )$$

$$\text{?} \text{indicates text missing or illegible when filed}$$

In other words, after the randomized response mechanism is applied, the random value [symbol] has a certain probability of being equal to [symbol] , and also has a certain probability of not being equal to [symbol] . The above randomized response mechanism is considered to have label differential privacy with δ=0 ((ϵ,0)-label differential privacy) because:

$$\frac{Pr [ \tilde{y} = 1 \vert y = 1 ]}{Pr [ \tilde{y} = 1 \vert y = 0 ]} = \frac{\frac{{e}^{\text{?}}}{1 + {e}^{\text{?}}}}{\frac{1}{1 + {e}^{\text{?}}}} = {e}^{\text{?}} = \frac{Pr [ \tilde{y} = 0 \vert y = 0 ]}{Pr [ \tilde{y} = 0 \vert y = 1 ]} \qquad ( 4 )$$

$$\text{?} \text{indicates text missing or illegible when filed}$$

In other words, the randomized response mechanism will satisfy ϵ-differential privacy.

The differential privacy and randomized response mechanism are discussed above. When applied to modifications to a plurality of ground-truth labels 105 at the client node 110, the values of the plurality of ground-truth labels 105 will be randomly changed according to a certain probability distribution. It is also equivalent to adding noise or interference to the set of ground-truth labels 105. Therefore, the protected label 305 may sometimes also be referred to as a noise label or an interference label.

Assume that the ground-truth label 105 of the i-th data sample 102 at the client node 110-k is represented as [symbol] , and the protected label 305 is represented as [symbol] . After the randomized response mechanism is applied, as a result, values of some ground-truth labels 105 may be changed (that is,

$${y}_{i}^{k} \neq {\overline{y}}_{i}^{k} ) ,$$

and some ground-truth labels 105 may remain unchanged (that is,

$${y}_{i}^{k} \neq {\overline{y}}_{i}^{k} ) ,$$

where k=1, 2, . . . N, i=1, 2, . . . , |Xₖ|, and |Xₖ| is the number of data samples of the client node 110-k.

Because the ground-truth label 105 under the binary classification problem is selected from two values, a change to the ground-truth label 105 may be considered as reversing the value of the ground-truth label 105. For example, if the value of the ground-truth label 105

$${y}_{i}^{k}$$

is 1, the value of the protected label 305

$${\overline{y}}_{i}^{k}$$

is 0 after reversion.

Through a randomized response mechanism, since the value of the ground-truth label 105 is randomly changed, the ground-truth label 105 cannot be derived from the protected label 305.

Continuing to refer back to FIG. 2, after obtaining the plurality of predicted scores and the plurality of protected labels, the client node 110 determines 225 metric information related to a predetermined performance indicator of the machine learning model 130. As mentioned above, on the basis of the modified set of protected labels, the metric information determined here is not an accurate metric and is referred to as “error metric information”.

In embodiments of the present disclosure, individual client nodes 110 determine metric information related to the performance indicator of the model based on local data sets (data samples and ground-truth labels). Metric information of a plurality of client nodes 110 may be aggregated to the server node 120. In this way, performance of machine learning model 130 is evaluated based on a complete data set for a plurality of client nodes.

The type of error metric information provided by the client node may depend on the performance indicator to be calculated, and on whether the client node 110 is to provide the protected label 305 to the server node.

In the following, some example performance indicators of the machine learning model 130 used to implement the binary classification task are first introduced, and then how the client node 110 feeds back error metric information to the server node is discussed in detail.

The predicted score output by the machine learning model 130 for a certain data sample is usually used to compare with a certain score threshold value, and based on the comparison results, it is determined that the data sample is predicted to belong to the first category or the second category. The prediction of the machine learning model 130 used to implement the binary classification task may have four results.

Specifically, for a certain data sample 102, if the ground-truth label 105 indicates that it belongs to the first category (positive sample), and the machine learning model 130 also predicts that it is a positive sample, then it is considered that the data sample is a true positive (TP) sample. If the ground-truth label 105 indicates that it belongs to the first category (positive sample), and the machine learning model 130 predicts that it is a negative sample, then the data sample is considered as a false negative sample (FN). If the ground-truth label 105 indicates that it belongs to the second category (negative sample), but the machine learning model 130 also predicts that it is a negative sample, then the data sample is considered to be true negative (TN). If the ground-truth label 105 indicates that it belongs to the second category (negative sample), but the machine learning model 130 predicts that it is a positive sample, then the data sample is considered to be a false positive (FP). These four results may be indicated by a confusion matrix in Table 1 below.

TABLE 1

ground-truth label

| | | Positive (P) | Negative (N) |
|---|---|---|---|
| predicted | P′ | True (TP) | False positive (FP) |
| result | N′ | False negative (FN) | True Negative (FN) |

When measuring the performance of the machine learning model 130, it is expected that performance indicator may be computed on the basis of the prediction results of the complete set of data samples of the plurality of client nodes 110 and the complete set of the ground-truth labels.

In some embodiments, the performance indicators of the machine learning model 130 may include an area under curve (AUC) of a receiver operating characteristic curve (ROC).

The ROC curve is a curve drawing on the coordinate axis based on different classification ways (setting different score threshold values), with the false positive sample ratio (FPR) as the X-axis and the true sample ratio (TPR) as the Y-axis. FPR may be defined as a ratio of the data sample that is actually a negative example and is wrongly judged as positive by the model, which is represented as FPR=FP/(FP+TN), where FP and TN represent the number of FP and TN counted in the complete set of data samples. TPR: a ratio of samples that are actually positive to those that are correctly judged as positive, represented as TPR=TP/(TP+FN). Based on each possible score threshold value, coordinate points of a plurality of (FPR, TPR) pairs may be computed, and these points may be connected into a line to form the ROC curve for a specific model.

By definition, AUC refers to the area below the ROC curve. One possible way to compute AUC is to use an approximation algorithm to compute the area under the ROC curve based on the definition of AUC.

In some embodiments, the AUC may also be determined from a probabilistic perspective. The AUC may be considered as the probability that a positive sample and a negative sample are randomly selected, and the predicted score given by the machine learning model to the positive sample is higher than the predicted score of the negative sample. That is, in the data sample set, the positive and negative samples meet to form a positive and negative sample pair, where the predicted score of the positive sample is greater than the proportion of the predicted score of the negative sample. If the model may output more positive samples with higher predicted score than negative samples, it may be considered that the AUC is higher, and the performance of the model is better. The range of AUC values is between 0.5 and 1. The closer the AUC is to 1, the better the performance of the model.

In the above AUC computing, the values of some metric parameters need to be determined based on the label data and prediction results of the data samples.

In addition to AUC, the performance indicators of the machine learning model 130 may further include precision, which is represented as Precision=TP/TP+FP. The precision represents the probability of a subset of data samples 102 predicted as positive samples being marked as positive samples. The performance indicators of machine learning model 130 may further include recall, which is represented as Recall=TP/TP+FN, that is, the probability of positive samples being predicted. The performance indicators of the machine learning model 130 may further include the P-R curve, which takes the recall rate as the horizontal axis and the precision as the vertical axis. The closer the P-R curve is to the upper right corner, the better the performance of the model. The area under the area under curve is referred to as an Average Precision Score (AP) score.

In the following, the determination of AUC will be mainly discussed as an example.

Continuing to refer to FIG. 2, after determining error metric information, the client node 110 sends 230 the determined error metric information to the server node 120.

As mentioned above, the client node 110 may choose to send a plurality of protected labels 305 as part of the error metric information to the server node, or choose not to send a protected label 305, but continue to measure values of parameters based on this.

In some embodiments where the protected labels 305 are sent directly, the client node 110 may directly determine the plurality of predicted scores and the plurality of protected labels 305 as error metric information and send it to the server node 120. As shown in FIG. 2, in the approach of sending error metric information 236, the client node 110 sends 240 the plurality of predicted scores and the plurality of protected labels to the server node 120. Therefore, the server node 120 may receive 242 the predicted scores and the protected labels from the client node 110. In these embodiments, for each data sample 102, the corresponding predicted scores and the protected labels may be sent to the server node 120 in pairs.

FIG. 2 also illustrates another approach of sending error metric information 238. In this approach, the client node 110 may determine the plurality of predicted scores as a first portion of the error metric information and send 244 this portion of information to the server node 120.

In some embodiments, before sending the predicted scores to the server node 120, the client node 110 may randomly adjust the order of the plurality of predicted scores and send the plurality of predicted scores to the server node in the adjusted order. By randomly adjusting the order, it may be avoided that in some special cases, after the plurality of data samples 102 are sequentially input into the model at the client node, the output predicted scores have a certain order, such as from large to small or from small to large, which may lead to certain information leakage. Randomly adjusting the order may further strengthen the data privacy protection.

After receiving 246 the predicted scores, the server node 120 ranks the set of predicted scores 248 from the plurality of client nodes 110, thereby obtaining the respective ranking results of the predicted scores from each client node 110 in the set of predicted scores.

In some embodiments, the server node 120 may rank the set of predicted scores in ascending order and assign a ranking value

$${r}_{i}^{k}$$

to each predicted score

$${s}_{i}^{k}$$

(the predicted score of the i^{th} data sample 102 of the client node 110-k). In some embodiments, the ranking value

$${r}_{i}^{k}$$

may indicate the number of other predicted score that the predicted score

$${s}_{i}^{k}$$

exceeds in the predicted score set. For example, in ascending order, the lowest predicted score is assigned a ranking value of 0, indicating that it does not exceed (greater than) any other predicted score. The next predicted score is assigned a ranking value of 1, indicating that it is greater than one predicted score in the set, and so on. The assignment of such ranking values is beneficial for subsequent computing.

In the approach 238, for the client node 110 that receives the predicted scores, the server node 120 sends 250 the ranking results of its multiple predicted scores in a complete set of predicted scores to the corresponding client node 110. After receiving 252 the sorted results, the client node 110 may determine 254 a second portion of the error metric information based on the local multiple protected labels 305 and the respective ranking results of the plurality of predicted scores. The second portion of the error metric information refers to values of metric parameters required to calculate a particular performance indicator of the machine learning model 130 in addition to the predicted score.

In some embodiments in which the AUC is determined as the performance indicator, the client node 110 may determine the number of first-type protected labels (referred to as “first number”) among the plurality of protected labels 305, where the first-type protected labels 305 indicates that the corresponding data sample 102 belongs to a first category, for example, indicates that the data sample 102 is a positive sample. In addition, the client node 110 may also determine the number of second-type protected labels (referred to as “second number”) among the plurality of protected labels 305, where the second-type protected labels indicates that the corresponding data sample belongs to a second category, for example, indicates that the data sample 102 is a negative sample. At the client node 110-k, the determination of the first number and the second number may be represented as follows:

$${localP}_{k} = {\sum }_{i = 1}^{\vert {X}_{k} \vert} {\overline{y}}_{i}^{k} \qquad ( 5 )$$

$${localN}_{k} = {\sum }_{i = 1}^{\vert {X}_{k} \vert} 1 - {\overline{y}}_{i}^{k} \qquad ( 6 )$$

|Xₖ| represents the represents the total number of the data samples of the client node 110-k;

$${\overline{y}}_{i}^{k}$$

represents the value of the ground-truth label corresponding to the i^{th} data sample; localPₖ represents the number of first-type label (labels indicating positive samples) among the ground-truth labels at the client node 110-k, and localNₖ represents the number of second-type label (labels indicating negative samples) among the ground-truth labels at the client node 110-k.

In the above equations (5) and (6), assume that the value of

$${\overline{y}}_{i}^{k}$$

is 1 for positive samples and 0 for negative samples. In this way, the number of positive samples indicated by the ground-truth label may be counted by summing

$${\overline{y}}_{i}^{k} .$$

The number of negative samples indicated by the ground-truth label may be counted by summing

$$( 1 - {\overline{y}}_{i}^{k} ) .$$

In other examples, if the ground-truth label uses other values to indicate positive samples and negative samples, localPₖ and localNₖ may also be counted in other ways, which is not limited herein. localPₖ and localNₖ may be determined as values of two metric parameters (error value) in the metric information at the client node 110-k.

In some embodiments, the client node 110 may also determine, based on the respective ranking results of the plurality of predicted scores, the number of predicted scores (referred to as a third number) of data samples corresponding to in the set of predicted scores that are exceeded by predicted scores of data samples (i.e., positive samples) corresponding to the first-type protected labels. This number may indicate the number of sample pairs in the set of data samples of the client node 110 for which positive samples are ranked higher than the remaining samples (in the case of ascending order). In some embodiments, at the client node 110-k, the third number may be determined by:

$${localSum}_{k} = {\sum }_{i = 1}^{\vert {X}_{k} \vert} {\overline{y}}_{i}^{k} {r}_{i}^{k} \qquad ( 7 )$$

localSumₖ represents the third number,

$${\overline{y}}_{i}^{k}$$

represents the value of the ground-truth label corresponding to the i^{th} data sample 102, and

$${r}_{i}^{k}$$

represents the ranking value of the predicted score corresponding to the i^{th} data sample 102. As mentioned earlier, the ranking value

$${r}_{i}^{k}$$

may be set to indicate the number of other predicted scores that the predicted score

$${s}_{i}^{k}$$

exceeds in the predicted score set. In equation (7) above, it is also assumed that for positive samples, the value of

$${\overline{y}}_{i}^{k}$$

is 1, and for negative samples, the value

$${\overline{y}}_{i}^{k} {r}_{i}^{k} ,$$

of is 0. In this way, by summing

$${\overline{y}}_{i}^{k}$$

the number of samples (also the number of such predicted scores) whose predicted scores of positive samples rank higher than the predicted scores of the remaining samples may be determined. localSumₖ may be determined as a value (error value) of another metric parameter in the metric information at the client node 110-k.

localPₖ, localNₖ and localSumₖ are all metric parameters that need to be determined in the example computing way of the AUC. The client node 110 may send 256 the values of these three metric parameters to server node 120 as the second portion of the error metric information. After receiving 258 the second portion of error metric information, the server node 120 may perform subsequent operations accordingly.

In some embodiments, different client nodes 110 may choose the approach 236 or the approach 238 to send respective error metric information to the server node 120.

Regardless of whether the protected labels 305 leave the client node 110, the ground-truth labels may obtain privacy protection. This is because the randomized response mechanism is immune post-processing. In other words, after applying the randomized response mechanism, the differential privacy protection capabilities are not eliminated regardless of how the protected labels and its associated statistical information are subsequently processed, that is, regardless of whether the protected label data is sent from the client node.

After receiving 235 the error metric information sent by respective client nodes 110, the server node 120 determines 260 the value of a performance indicator of the machine learning model 130 based on the error metric information from the plurality of client nodes 110. Because error metric information is used, the value of the determined performance indicator is also referred to as an error value.

On the basis of the metric information, the calculation of the performance indicator depends on the obtained metric information and the type of performance indicator to be determined. For AUC, there may also be various algorithms for flexible determination.

In some embodiments, if the server node 120 receives from the plurality of client nodes 110 the values of the metric parameters localPₖ, localNₖ and localSumₖ transmitted by the approach 238, respectively, the server node 120 may aggregate the values of these metric parameters of the plurality of client nodes 110 by parameter, respectively, to obtain an aggregate value (global value) for each metric parameter, as follows:

$$\overline{P} = {\sum }_{k} {localP}_{k} \qquad ( 8 )$$

$$\overline{N} = {\sum }_{k} {localN}_{k} \qquad ( 9 )$$

$$globalSum = {\sum }_{k} {localSum}_{k} \qquad ( 10 )$$

P̅ denotes a total number (referred to as “first total number”) of the first-type protected labels (labels indicating positive samples) among all the protected labels of the plurality of client nodes 110, N̅ represents a total number (referred to as “second total number”) of the second-type protected labels (labels indicating negative samples) among all protected labels of the plurality of client nodes 110, globalSum represents a third total number of predicted scores in the set of predicted scores that are exceeded by predicted scores of data samples corresponding to the first-type protected labels. Since the statistics are performed on the basis of the protected labels, there may be an error between P̅, N̅ and globalSum, and the value calculated based on the ground-truth labels of the client node.

In some embodiments, if the server node 120 receives error metric information that is predicted scores and protected labels from the plurality of client nodes 110, for example, such error metric information is received by the approach 236. The server node 120 may aggregate the predicted scores and the protected labels of these client nodes 110 together, and P̅, N̅ and globalSum are obtained by gathering statistics based on a similar manner as discussed above at the client node.

In some embodiments, if the server node 120 receives error metric information that is predicted scores and protected labels from a certain client node 110 or a certain portion of client nodes 110, for example, such error metric information is received by the approach 236. The server node 120 calculates P̅, N̅ and globalSum corresponding to each client node in a similar manner as discussed above at the client node. The server node 120 may also aggregate the predicted scores and the protected labels of some of the client nodes 110 in a similar manner as discussed above at the client node, the number of first-type protected labels, the number of second-type protected labels, and the number of predicted scores in the set of predicted scores that are exceeded by predicted scores of data samples corresponding to the first-type protected labels corresponding to this portion of client nodes are obtained by gathering statistics. The server node 120 then aggregates the information by gathering statistics with localPₖ, localNₖ and localSumₖ received directly from the remaining client nodes to determine P̅, N̅ and globalSum.

In some embodiments, based on P̅, N̅ and globalSum, the server node 120 may calculate the value of AUC (the value calculated here is the error value, expressed as AUC_corr) by:

$$AUC\_corr = \frac{globalSum - \frac{P ( P - 1 )}{2}}{\overline{P} \overline{N}} \qquad ( 11 A )$$

In some embodiments, if the server node 120 receives predicted scores and protected labels from the plurality of client nodes 110 by approach 236, the server node 120 may also calculate AUC by other approaches. In particular, the server node 120 may aggregate the received predicted scores and the protected labels. The server node 120 may determine, in the set of protected labels, the number of positive samples indicated by the protected labels and the number of negative samples indicated by the protected labels. In addition, the server node 120 may determine, based on the set of predicted scores, the number of predicted scores of positive samples that are greater than the predicted scores of negative samples among all data samples. The server node 120 may in turn calculate the value of AUC (that is, error value) based on these three numbers.

Assume that based on the number of protected labels and predicted scores, it may be determined that the total number of data samples 102 at N client nodes 110 is L, and the number of positive samples indicated by the ground-truth label is m, and the number of negative samples is n. In addition, the predicted score corresponding to each data sample 102 is sᵢ, i∈[1, L]. By traversing the pairwise combination of positive samples and negative samples, m*n sample pairs Pi, i∈[1, m*n] may be formed, and the AUC may be determined as follows:

$$AUC\_corr = \frac{\sum I ( {P}_{i} )}{mn} , where \qquad ( 11 B )$$

$$I ( {P}_{i} ) = \{ \begin{matrix}1 , the predicted score of positive samples in P \\ is greater than that of negative samples \\ 0 , other cases\end{matrix}$$

The above discusses some example calculating ways for AUC. If applicable, the AUC may also be determined from a probabilistic and statistical perspective based on other ways.

In some embodiments, in addition to AUC, other performance indicator of the machine learning model 130 may also be evaluated, as long as such performance indicator may be determined from the plurality of predicted scores and the plurality of ground-truth labels. The embodiments of the present disclosure are not limited in this respect.

In order to obtain a more accurate value of the performance indicator, the server node 120 determines 265 a corrected value of the predetermined performance indicator by correcting the error value based on the error value of the performance indicator.

In some embodiments, a mapping relationship between error values and corrected values of the performance indicator may be determined, and the error value is corrected based on the mapping relationship.

In some embodiments, the mapping relation between the error values and the corrected values for the AUC may be determined based on the first total number of the first-type protected labels and the second total number of the second-type protected labels among the set of protected labels that are involved at the N client nodes 110. As an example, the mapping relationship between the error value of the AUC (AUC_corr) and the corrected value (denoted as AUC_real) may be expressed as follows:

$$AUC\_corr = ( 1 - α - β ) * AUC\_real + \frac{α + β}{2} , where \qquad ( 12 )$$

$$α = \frac{( 1 - π ) {ρ}_{-}}{π ( 1 - {ρ}_{-} ) + ( 1 - π ) {ρ}_{-}}$$

$$β = \frac{{πρ}_{+}}{{πρ}_{+} + ( 1 - π ) ( 1 - {ρ}_{-} )}$$

π=P(Y=1) refers to the proportion of positive samples in the set of data samples indicated by the ground-truth labels. ρ+ and ρ− refer to the rate of change of the ground-truth labels for the positive samples and negative samples in the application of the randomized response mechanism, respectively.

For π, because the server node 120 does not know the situation of the ground-truth labels, the proportion of positive samples in the set of data samples indicated by the ground-truth labels may be estimated by the protected labels. Assuming that M, N are the number of positive samples and negative samples in the set of data samples indicated by the ground-truth labels, P̅, N̅ are the first total number of the first-type protected labels and the second total number of the second-type protected labels determined from the error metric information provided by the client node 110. It can be determined that M+N=P̅+N̅, that is, the total number of samples or labels does not change. In addition, M(1−ρ₊)+Nρ₋=P̅ may also be determined. From these two equations, the following may be obtained:

$$M = \frac{\overline{P} ( 1 - {ρ}_{-} ) - \overline{N} {ρ}_{-}}{1 - {ρ}_{+} - {ρ}_{-}} \qquad ( 13 )$$

$$N = \overline{P} + \overline{N} - M \qquad ( 14 )$$

Accordingly,

$$π = \frac{M}{M + N}$$

may be determined.

Therefore, by equation (12) above, the AUC_real may be calculated from the AUC_corr when π, ρ+ and ρ− are known.

It will be appreciated that there may still be some error between the calculated AUC_real and the AUC based on the statistics of ground-truth labels, after correcting the error value of the AUC. However, according to the result of repeated testing by the inventors, it may be determined that such an error is small within an allowable range. In fact, strictly speaking, even if a ground-truth label is provided, in many algorithms for calculating the AUC, the true value of the AUC, that is, the area under the ROC curve, is approximated by means of approximation. Therefore, in a scenario where privacy protection needs to be performed on label data, according to various embodiments of the present disclosure, a server node is allowed to determine a more accurate performance indicator while obtaining differential privacy protection of data.

In some embodiments, in addition to the AUC, values of other performance indicators may also be calculated. The server node 120 may also correct error values of these performance indicators by setting other mapping relationships, so as to obtain more accurate values of performance indicators.

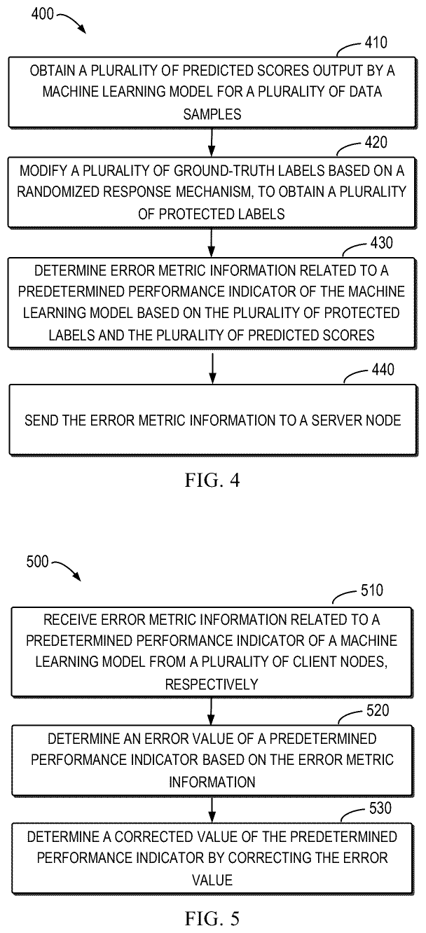

FIG. 4 illustrates a flowchart of a process 400 for model performance evaluation at a client node according to some embodiments of the disclosure. The process 400 may be implemented at the client node 110.

At block 410, the client node 110 obtains a plurality of predicted scores output by a machine learning model for a plurality of data samples. The plurality of predicted scores respectively indicates predicted probabilities that the plurality of data samples belong to a first category or a second category.

At block 420, the client node 110 modifies a plurality of ground-truth labels based on a randomized response mechanism, to obtain a plurality of protected labels. The plurality of ground-truth labels respectively labeling that the plurality of data samples belong to the first category or the second category.

At block 430, the client node 110 determines error metric information related to a predetermined performance indicator of the machine learning model based on the plurality of protected labels and the plurality of predicted scores. At block 440, the client node 110 sends the error metric information to a server node.

In some embodiments, determining the error metric information comprises: determining the plurality of predicted scores and the plurality of protected labels as the error metric information.

In some embodiments, the plurality of predicted scores are determined to be a first portion of the error metric information and are sent to the server node. In some embodiments, determining the error metric information further comprises: after sending the plurality of predicted scores to the server node, receiving, from the server node, respective ranking results of the plurality of predicted scores in a set of predicted scores, the set of predicted scores comprising predicted scores sent by a plurality of client nodes comprising the client node; and determining a second portion of the error metric information based on the plurality of protected labels and the respective ranking results of the plurality of predicted scores.

In some embodiments, determining the second portion of the error metric information comprises: determining a first number of first-type protected labels among the plurality of protected labels, a first-type protected label indicating that a corresponding data sample belongs to the first category: determining a second number of second-type protected labels among the plurality of protected labels, a second-type protected label indicating that a corresponding data samples belong to the second category; and determining, based on the respective ranking results of the plurality of predicted scores, a third number of predicted scores in the set of predicted scores that are exceeded by predicted scores of data samples corresponding to the first-type protected labels.

In some embodiments, sending the error metric information comprises: adjusting an order of the plurality of predicted scores; and sending the plurality of predicted scores to the server node in the adjusted order.

In some embodiments, the predetermined performance indicator at least comprises an area under curve (AUC) of a receiver operating characteristic curve (ROC).

FIG. 5 illustrates a flowchart of a process 500 for model performance evaluation at a server node according to some embodiments of the disclosure. The process 500 may be implemented at the server node 120.

At block 510, the server node 120 receives error metric information related to a predetermined performance indicator of a machine learning model from a plurality of client nodes, respectively. The error metric information is determined by a client node based on a plurality of protected labels of the corresponding client. The plurality of protected labels are generated by applying a randomized response mechanism to the plurality of ground-truth labels.

At block 520, the server node 120 determines an error value of a predetermined performance indicator based on the error metric information. At block 530, the server node 120 determines a corrected value of the predetermined performance indicator by correcting the error value.

In some embodiments, receiving the error metric information comprises: for a given client node of the plurality of client nodes, receiving, from the given client node, the plurality of protected labels and a plurality of predicted scores, the plurality of predicted scores being determined by the machine learning model based on a plurality of data samples, and the plurality of predicted scores respectively indicating predicted probabilities that the plurality of data samples belong to a first category or a second category.

In some embodiments, determining the error value of the predetermined performance indicator comprises: determining a first total number of first-type protected labels and a second total number of second-type protected labels in a set of protected labels received from the plurality of client nodes, a first-type protected label indicating that a corresponding data sample belongs to the first category, a second-type protected label indicating that a corresponding data sample belongs to the second category: sorting a set of predicted scores received from the plurality of client nodes: determining, based on respective ranking results of predicted scores in the set of predicted scores, a third total number of predicted scores in the set of predicted scores that are exceeded by predicted scores of data samples corresponding to the first-type protected labels; and calculating the error value of the predetermined performance indicator based on the first total number, the second total number, and the third total number.

In some embodiments, receiving the error metric information comprises: for a given client node of the plurality of client nodes, receiving, from the given client node, a plurality of predicted scores as a first portion of the error metric information, the plurality of predicted scores being determined by the machine learning model based on a plurality of data samples, and the plurality of predicted scores respectively indicating predicted probabilities that the plurality of data samples belong to a first category or a second category.

In some embodiments, the process 500 further comprises: determining ranking results of the plurality of predicted scores from the given client node in a set of predicted scores, the set of predicted scores comprising the predicted scores sent by the plurality of client nodes; and sending the ranking results of the plurality of predicted scores to the given client node.

In some embodiments, receiving the error metric information further comprises: receiving, from the given client node, a first number of first-type protected labels in the plurality of protected labels and a second number of second-type protected labels in the plurality of protected labels at the given client node, a first-type protected label indicating that a corresponding data sample belongs to the first category, and a second-type protected label indicating that a corresponding data sample belongs to the second category; and receiving, from the given client node, a third number indicating the number of predicted scores in the set of predicted scores that are exceeded by predicted scores of data samples corresponding to the first-type protected labels.

In some embodiments, determining the error value of the predetermined performance indicator comprises: obtaining a first total number of the first-type protected labels by aggregating the first number of the first-type protected labels received from the plurality of client nodes; obtaining a second total number of the second-type protected labels by aggregating the second number of second-type protected labels received from the plurality of client nodes; obtaining a third total number of predicted scores in the set of predicted scores that are exceeded by predicted scores of data samples corresponding to the first-type protected labels, by aggregating the third number of predicted scores received from the plurality of client nodes; and calculating the error value of the predetermined performance indicator based on the first total number, the second total number, and the third total number.

In some embodiments, determining the corrected value of the predetermined performance indicator comprises: obtaining a first total number of first-type protected labels and a second total number of second-type protected labels in a set of protected labels at the plurality of client nodes, a first-type protected label indicating that a corresponding data sample belongs to the first category, and a second-type protected label indicating that a corresponding data sample belongs to the second category: determining a mapping relationship between error values and corrected values of the predetermined performance indicator based on the first total number and the second total number; and calculating the corrected value of the predetermined performance indicator from the error value based on the mapping relationship.

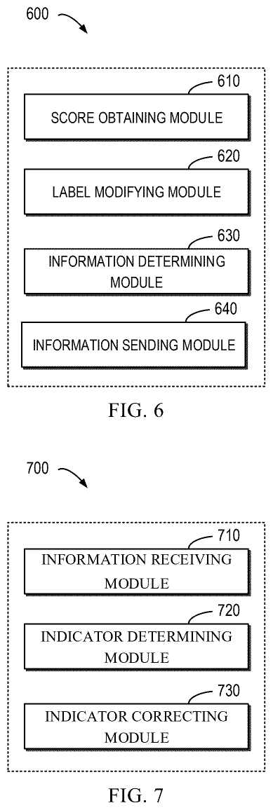

FIG. 6 illustrates a block diagram of an apparatus 600 for model performance evaluation at a client node according to some embodiments of the disclosure. The apparatus 600 may be implemented as or included in the client node 110. Each module/component in the apparatus 600 may be implemented in hardware, software, firmware, or any combination thereof.

As illustrated, the apparatus 600 includes a score obtaining module 610 configured to obtain a plurality of predicted scores output by a machine learning model for a plurality of data samples. The plurality of predicted scores respectively indicating predicted probabilities that the plurality of data samples belong to a first category or a second category. The apparatus 600 further includes a label modifying module 620, configured to modify a plurality of ground-truth labels based on a randomized response mechanism, to obtain a plurality of protected labels, the plurality of ground-truth labels respectively labeling that the plurality of data samples belong to the first category or the second category. In addition, the apparatus 600 further includes an information determining module 630 configured to determine error metric information related to a predetermined performance indicator of the machine learning model based on the plurality of protected labels and the plurality of predicted scores; and an information sending module 640 configured to send the error metric information to a server node.

In some embodiments, the information determination module 630 includes a first determining module configured to determine the plurality of predicted scores and the plurality of protected labels as the error metric information.

In some embodiments, the plurality of predicted scores are determined to be a first portion of the error metric information and are sent to the server node. In some embodiments, the information determining module 630 includes: a ranking result receiving module configured to, after sending the plurality of predicted scores to the server node, receive, from the server node, respective ranking results of the plurality of predicted scores in a set of predicted scores, the set of predicted scores comprising predicted scores sent by a plurality of client nodes comprising the client node; and a second determining module configured to determine a second portion of the error metric information based on the plurality of protected labels and the respective ranking results of the plurality of predicted scores.

In some embodiments, the second determining module includes: a first number determining module configured to determine a first number of first-type protected labels among the plurality of protected labels, a first-type protected label indicating that a corresponding data sample belongs to the first category: a second number determining module configured to a second number of second-type protected labels among the plurality of protected labels, a second-type protected label indicating that a corresponding data samples belong to the second category; and a third number determination module configured to determine, based on the respective ranking results of the plurality of predicted scores, a third number of predicted scores in the set of predicted scores that are exceeded by predicted scores of data samples corresponding to the first-type protected labels.

In some embodiments, the information sending module 640 comprises: an order adjusting module configured to adjust an order of the plurality of predicted scores; and an in-order sending module configured to send the plurality of predicted scores to the server node in the adjusted order.

In some embodiments, the predetermined performance indicator comprises at least the area under curve (AUC) of a receiver operator characteristic curve (ROC).

FIG. 7 illustrates a block diagram of an apparatus 700 for model performance evaluation at a server node according to some embodiments of the disclosure. The apparatus 700 may be implemented as or included in the server node 120. Each module/component in the apparatus 700 may be implemented by hardware, software, firmware, or any combination thereof.

As illustrated, apparatus 700 includes an information receiving module 710 configured to receive, error metric information related to a predetermined performance indicator of a machine learning model from a plurality of client nodes, respectively. The error metric information is determined by a client node based on a plurality of protected labels of the corresponding client. The plurality of protected labels are generated by applying a randomized response mechanism to a plurality of ground-truth labels. The apparatus 700 further includes an indicator determining module 720 configured to determine an error value of the predetermined performance indicator based on the error metric information; and an indicator correcting module 730 configured to determine a corrected value of the predetermined performance indicator by correcting the error value.

In some embodiments, the information receiving module 710 includes a first receiving module configured to, for a given client node of the plurality of client nodes, receive, from the given client node, the plurality of protected labels and a plurality of predicted scores, the plurality of predicted scores being determined by the machine learning model based on a plurality of data samples, and the plurality of predicted scores respectively indicating predicted probabilities that the plurality of data samples belong to a first category or a second category.

In some embodiments, the indicator determination module 720 includes a first total number determining module configured to determine a first total number of first-type protected labels and a second total number of second-type protected labels in a set of protected labels received from the plurality of client nodes, a first-type protected label indicating that a corresponding data sample belongs to the first category, a second-type protected label indicating that a corresponding data sample belongs to the second category: a sorting module configured to sort a set of predicted scores received from the plurality of client nodes: a second total number determining module configured to determine, based on respective ranking results of predicted scores in the set of predicted scores, a third total number of predicted scores in the set of predicted scores that are exceeded by predicted scores of data samples corresponding to the first-type protected labels; and a total number-based first indicator determining module configured to calculate the error value of the predetermined performance indicator based on the first total number, the second total number, and the third total number.

In some embodiments, the information receiving module 710 includes a second receiving module configured to, for a given client node of the plurality of client nodes, receive, from the given client node, a plurality of predicted scores as a first portion of the error metric information, the plurality of predicted scores being determined by the machine learning model based on a plurality of data samples, and the plurality of predicted scores respectively indicating predicted probabilities that the plurality of data samples belong to a first category or a second category.

In some embodiments, apparatus 700 further comprises: a ranking determining module configured to determine ranking results of the plurality of predicted scores from the given client node in a set of predicted scores, the set of predicted scores comprising the predicted scores sent by the plurality of client nodes; and a second sending module configured to send the ranking results of the plurality of predicted scores to the given client node.

In some embodiments, the information receiving module 710 also includes a third receiving module configured to receive, from the given client node, a first number of first-type protected labels in the plurality of protected labels and a second number of second-type protected labels in the plurality of protected labels at the given client node, a first-type protected label indicating that a corresponding data sample belongs to the first category, and a second-type protected label indicating that a corresponding data sample belongs to the second category; and a fourth receiving module configured to receive, from the given client node, a third number indicating the number of predicted scores in the set of predicted scores that are exceeded by predicted scores of data samples corresponding to the first-type protected labels.

In some embodiments, the indicator determining module 720 comprises: a first aggregating module configured to obtain a first total number of the first-type protected labels by aggregating the first number of the first-type protected labels received from the plurality of client nodes: a second aggregating module configured to obtain a second total number of the second-type protected labels by aggregating the second number of second-type protected labels received from the plurality of client nodes; a third aggregating module configured to obtain a third total number of predicted scores in the set of predicted scores that are exceeded by predicted scores of data samples corresponding to the first-type protected labels, by aggregating the third number of predicted scores received from the plurality of client nodes; and a total number-based second indicator determining module, configured to calculate the error value of the predetermined performance indicator based on the first total number, the second total number, and the third total number.

In some embodiments, the indicator correcting module 730 includes: a number obtaining module configured to obtain a first total number of first-type protected labels and a second total number of second-type protected labels in a set of protected labels at the plurality of client nodes, a first-type protected label indicating that a corresponding data sample belongs to the first category, and a second-type protected label indicating that a corresponding data sample belongs to the second category: a mapping determining module configured to determine a mapping relationship between error values and corrected values of the predetermined performance indicator based on the first total number and the second total number; and a corrected value determining module configured to calculate the corrected value of the predetermined performance indicator from the error value based on the mapping relationship.

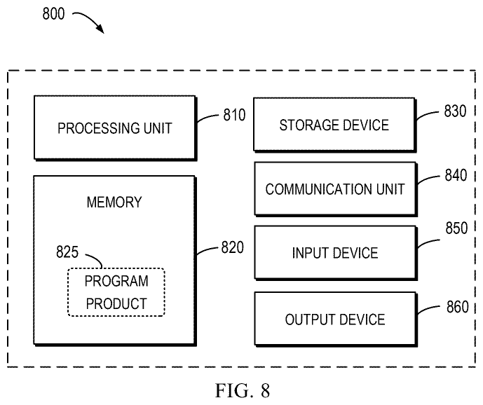

FIG. 8 illustrates a block diagram of a computing device/system 800 in which one or more embodiments of the present disclosure may be implemented. It would be appreciated that the computing device/system 800 illustrated in FIG. 8 is only an example and should not be configured as implying any limitation on the functionality and scope of the embodiments described herein. The computing device/system 800 shown in FIG. 8 may be used to implement the client node 110 or server node 120 of FIG. 1.

As shown in FIG. 8, the computing device/system 800 is in the form of a general purpose computing device. The components of computing device/system 800 may include, but are not limited to, one or more processors or processing units 810, a memory 820, a storage device 830, one or more communication units 840, one or more input devices 850, and one or more output devices 860. The processing unit 810 may be an actual or virtual processor and can execute various processes according to programs stored in the memory 820. In a multiprocessor system, multiple processing units execute computer executable instructions in parallel to improve the parallel processing capabilities of the computing device/system 800.

The computing device/system 800 typically includes a variety of computer storage medium. Such medium may be any available medium that is accessible to the computing device/system 800, including but not limited to volatile and non-volatile medium, removable and non-removable medium. The memory 820 may be volatile memory (for example, a register, cache, a random access memory (RAM)), non-volatile memory (for example, a read-only memory (ROM), an electrically erasable programmable read-only memory (EEPROM), a flash memory), or any combination thereof. The storage device 830 may be any removable or non-removable medium and may include a machine-readable medium, such as a flash drive, a magnetic disk, or any other medium, which can be used to store information and/or data (such as training data for training) and can be accessed within computing device/system 800.

The computing device/system 800 may further include additional removable/non-removable, volatile/non-volatile storage medium. Although not shown in FIG. 8, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 820 may include a computer program product 825, which has one or more program modules configured to perform various methods or acts of various embodiments of the present disclosure.

The communication unit 840 communicates with a further computing device through the communication medium. In addition, functions of components in the computing device/system 800 may be implemented by a single computing cluster or multiple computing machines, which can communicate through a communication connection. Therefore, the computing device/system 800 may be operated in a networking environment using a logical connection with one or more other servers, a network personal computer (PC), or another network node.

The input device 850 may be one or more input devices, such as a mouse, a keyboard, a trackball, etc. The output device 860 may be one or more output devices, such as a display, a speaker, a printer, etc. The computing device/system 800 may also communicate with one or more external devices (not shown) through the communication unit 840 as required. The external device, such as a storage device, a display device, etc., communicate with one or more devices that enable users to interact with the computing device/system 800, or communicate with any device (for example, a network card, a modem, etc.) that makes the computing device/system 800 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above.

According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method for model performance evaluation, comprising:
obtaining, at a client node, a plurality of predicted scores output by a machine learning model for a plurality of data samples, the plurality of predicted scores respectively indicating predicted probabilities that the plurality of data samples belong to a first category or a second category;
modifying a plurality of ground-truth labels based on a randomized response mechanism, to obtain a plurality of protected labels, the plurality of ground-truth labels respectively labeling that the plurality of data samples belong to the first category or the second category;
determining error metric information related to a predetermined performance indicator of the machine learning model based on the plurality of protected labels and the plurality of predicted scores; and
sending the error metric information to a server node.

2. The method of claim 1, wherein determining the error metric information comprises:
determining the plurality of predicted scores and the plurality of protected labels as the error metric information.

3. The method of claim 1, wherein the plurality of predicted scores are determined to be a first portion of the error metric information and are sent to the server node, and wherein determining the error metric information further comprises:
after sending the plurality of predicted scores to the server node, receiving, from the server node, respective ranking results of the plurality of predicted scores in a set of predicted scores, the set of predicted scores comprising predicted scores sent by a plurality of client nodes comprising the client node; and
determining a second portion of the error metric information based on the plurality of protected labels and the respective ranking results of the plurality of predicted scores.

4. The method of claim 3, wherein determining the second portion of the error metric information comprises:
determining a first number of first-type protected labels among the plurality of protected labels, a first-type protected label indicating that a corresponding data sample belongs to the first category;
determining a second number of second-type protected labels among the plurality of protected labels, a second-type protected label indicating that corresponding data samples belong to the second category; and
determining, based on the respective ranking results of the plurality of predicted scores, a third number of predicted scores in the set of predicted scores that are exceeded by predicted scores of data samples corresponding to the first-type protected labels.

5. The method of claim 3, wherein sending the error metric information comprises:
adjusting an order of the plurality of predicted scores; and
sending the plurality of predicted scores to the server node in the adjusted order.

6. The method of claim 1, wherein the predetermined performance indicator at least comprises an area under curve (AUC) of a receiver operating characteristic curve (ROC).

7. A method for model performance evaluation, comprising:
receiving, at a server node, error metric information related to a predetermined performance indicator of a machine learning model from a plurality of client nodes, respectively, the error metric information being determined by a client node based on a plurality of protected labels of the corresponding client, the plurality of protected labels being generated by applying a randomized response mechanism to a plurality of ground-truth labels;
determining an error value of the predetermined performance indicator based on the error metric information; and
determining a corrected value of the predetermined performance indicator by correcting the error value.

8. The method of claim 7, wherein receiving the error metric information comprises:
for a given client node of the plurality of client nodes,
receiving, from the given client node, the plurality of protected labels and a plurality of predicted scores, the plurality of predicted scores being determined by the machine learning model based on a plurality of data samples, and the plurality of predicted scores respectively indicating predicted probabilities that the plurality of data samples belong to a first category or a second category.

9. The method of claim 8, wherein determining the error value of the predetermined performance indicator comprises:
determining a first total number of first-type protected labels and a second total number of second-type protected labels in a set of protected labels received from the plurality of client nodes, a first-type protected label indicating that a corresponding data sample belongs to the first category, a second-type protected label indicating that a corresponding data sample belongs to the second category;
sorting a set of predicted scores received from the plurality of client nodes;
determining, based on respective ranking results of predicted scores in the set of predicted scores, a third total number of predicted scores in the set of predicted scores that are exceeded by predicted scores of data samples corresponding to the first-type protected labels; and
calculating the error value of the predetermined performance indicator based on the first total number, the second total number, and the third total number.

10. The method of claim 7, wherein receiving the error metric information comprises:
for a given client node of the plurality of client nodes,
receiving, from the given client node, a plurality of predicted scores as a first portion of the error metric information, the plurality of predicted scores being determined by the machine learning model based on a plurality of data samples, and the plurality of predicted scores respectively indicating predicted probabilities that the plurality of data samples belong to a first category or a second category.

11. The method of claim 10, further comprising:
determining ranking results of the plurality of predicted scores from the given client node in a set of predicted scores, the set of predicted scores comprising the predicted scores sent by the plurality of client nodes; and
sending the ranking results of the plurality of predicted scores to the given client node.

12. The method of claim 11, wherein receiving the error metric information further comprises:
receiving, from the given client node, a first number of first-type protected labels in the plurality of protected labels and a second number of second-type protected labels in the plurality of protected labels at the given client node, a first-type protected label indicating that a corresponding data sample belongs to the first category, and a second-type protected label indicating that a corresponding data sample belongs to the second category; and
receiving, from the given client node, a third number indicating the number of predicted scores in the set of predicted scores that are exceeded by predicted scores of data samples corresponding to the first-type protected labels.

13. The method of claim 7, wherein determining the error value of the predetermined performance indicator comprises:
obtaining a first total number of the first-type protected labels by aggregating the first number of the first-type protected labels received from the plurality of client nodes;
obtaining a second total number of the second-type protected labels by aggregating the second number of second-type protected labels received from the plurality of client nodes;
obtaining a third total number of predicted scores in the set of predicted scores that are exceeded by predicted scores of data samples corresponding to the first-type protected labels, by aggregating the third number of predicted scores received from the plurality of client nodes; and
calculating the error value of the predetermined performance indicator based on the first total number, the second total number, and the third total number.

14. The method of claim 7, wherein determining the corrected value of the predetermined performance indicator comprises:
obtaining a first total number of first-type protected labels and a second total number of second-type protected labels in a set of protected labels at the plurality of client nodes, a first-type protected label indicating that a corresponding data sample belongs to the first category, and a second-type protected label indicating that a corresponding data sample belongs to the second category;
determining a mapping relationship between error values and corrected values of the predetermined performance indicator based on the first total number and the second total number; and
calculating the corrected value of the predetermined performance indicator from the error value based on the mapping relationship.

15. (canceled)

16. (canceled)

17. An electronic device, comprising:
at least one processing unit; and
at least one memory coupled to the at least one processing unit and storing instructions executable by the at least one processing unit, the instructions, when executed by the at least one processing unit, causing the device to perform acts comprising:
receiving, at a server node, error metric information related to a predetermined performance indicator of a machine learning model from a plurality of client nodes, respectively, the error metric information being determined by a client node based on a plurality of protected labels of the corresponding client, the plurality of protected labels being generated by applying a randomized response mechanism to a plurality of ground-truth labels;
determining an error value of the predetermined performance indicator based on the error metric information; and
determining a corrected value of the predetermined performance indicator by correcting the error value.

18. (canceled)

19. (canceled)

20. (canceled)

21. The electronic device of claim 17, wherein receiving the error metric information comprises:
for a given client node of the plurality of client nodes,
receiving, from the given client node, the plurality of protected labels and a plurality of predicted scores, the plurality of predicted scores being determined by the machine learning model based on a plurality of data samples, and the plurality of predicted scores respectively indicating predicted probabilities that the plurality of data samples belong to a first category or a second category.

22. The electronic device of claim 21, wherein determining the error value of the predetermined performance indicator comprises:
determining a first total number of first-type protected labels and a second total number of second-type protected labels in a set of protected labels received from the plurality of client nodes, a first-type protected label indicating that a corresponding data sample belongs to the first category, a second-type protected label indicating that a corresponding data sample belongs to the second category;
sorting a set of predicted scores received from the plurality of client nodes;
determining, based on respective ranking results of predicted scores in the set of predicted scores, a third total number of predicted scores in the set of predicted scores that are exceeded by predicted scores of data samples corresponding to the first-type protected labels; and
calculating the error value of the predetermined performance indicator based on the first total number, the second total number, and the third total number.

23. The electronic device of claim 17, wherein receiving the error metric information comprises:
for a given client node of the plurality of client nodes,
receiving, from the given client node, a plurality of predicted scores as a first portion of the error metric information, the plurality of predicted scores being determined by the machine learning model based on a plurality of data samples, and the plurality of predicted scores respectively indicating predicted probabilities that the plurality of data samples belong to a first category or a second category.

24. The electronic device of claim 23, the acts further comprising:
determining ranking results of the plurality of predicted scores from the given client node in a set of predicted scores, the set of predicted scores comprising the predicted scores sent by the plurality of client nodes; and
sending the ranking results of the plurality of predicted scores to the given client node.

25. The electronic device of claim 24, wherein receiving the error metric information further comprises:
receiving, from the given client node, a first number of first-type protected labels in the plurality of protected labels and a second number of second-type protected labels in the plurality of protected labels at the given client node, a first-type protected label indicating that a corresponding data sample belongs to the first category, and a second-type protected label indicating that a corresponding data sample belongs to the second category; and
receiving, from the given client node, a third number indicating the number of predicted scores in the set of predicted scores that are exceeded by predicted scores of data samples corresponding to the first-type protected labels.
